(19) United States
(12) Patent Application Publication
(10) Pub. No.: US 2009/0153694 A1
(43) Pub. Date: Jun. 18, 2009

(54) MOVING IMAGE GENERATING APPARATUS, MOVING IMAGE SHOOTING APPARATUS, MOVING IMAGE GENERATING METHOD, AND PROGRAM

(76) Inventor: Katsumi TAKAYAMA, Kurokawa-gun (JP)

Correspondence Address: BIRCH STEWART KOLASCH & BIRCH, PO BOX 747, FALLS CHURCH, VA, 22040-0747, US

(21) Appl. No.: 12/332,630

(22) Filed: Dec. 11, 2008

(30) Foreign Application Priority Data
Dec. 14, 2007 (JP) 2007-323755

(51) Int. Cl. H04N 5/228; G06K 9/46

(52) U.S. Cl. 348/222.1; 382/190

(57) ABSTRACT

A moving image generating apparatus comprises: an obtaining device which obtains a series of image data in which high-resolution first image data obtained at a predetermined frame rate and low-resolution second image data obtained at times that are different from the times of the obtainment of the first image data are arranged in a given order; a characteristic point extracting device which extracts characteristic points in the first image data; a corresponding point detecting device which detects corresponding points in the second image data, the corresponding points corresponding to characteristic points in first image data obtained immediately before the second image data; and a generating device which generates high-resolution image data having a content that is the same as that of the second image data by modifying the first image data based on the relationship between the characteristic points extracted by the characteristic point extracting device and the corresponding points detected by the corresponding point detecting device.

### BACKGROUND OF THE INVENTION

1. Field of the Invention

The present invention relates to a moving image generating apparatus, a moving image shooting apparatus, a moving image generating method and a program, and specifically relates to a moving image generating apparatus, a moving image shooting apparatus, a moving image generating method and a program, which enables generation of high-frame rate moving images. The present invention also relates to a recording medium which stores computer readable code of the program.

2. Description of the Related Art

In order to obtain a favorable moving image, a method in which an image between two high-resolution images is generated by means of interpolation to raise the frame rate of a moving image is taken. However, there is no choice but to estimate the movement of subjects during frame reading, and accordingly, if an error occurs in the estimation, the image may be broken.

In order to raise a frame rate, in general, it is necessary to reduce the number of output pixels because the number of pixels an image pickup device can output and the frame rate are inversely proportional to each other. In order to overcome this drawback, the following techniques are disclosed.

Japanese Patent Application Laid-Open No. 2007-28208 discloses an invention in which a high-temporal and spatial resolution image is generated by performing interlaced operation of an image pickup device to perform interpolation using adjacent frames.

Japanese Patent Application Laid-Open No. 2004-180240 discloses an invention in which an image of the whole scene of an observation target is obtained as a low-resolution whole image, and a detailed image is obtained as a high-resolution partial image only with regard to an attention part of the entire image.

Japanese Patent Application Laid-Open No. 2005-191813 discloses an invention in which a moving image with a doubled frame rate is obtained by shifting the timings for driving two CCDs to perform shooting.

Japanese Patent Application Laid-Open No. 2005-217970 discloses an invention in which a high resolution is achieved for a horizontal resolution by arranging three CCDs with their pixels horizontally shifted from one another, and a high frame rate is achieved by performing interlaced reading.

### SUMMARY OF THE INVENTION

The invention disclosed in Japanese Patent Application Laid-Open No. 2007-28208 has a problem in that although it combines images obtained as a result of interlaced operation of an image pickup device, it is difficult, in reality, to combine two images with different exposure timings without breaking.

In the invention disclosed in Japanese Patent Application Laid-Open No. 2004-180240, a low-resolution image and a high-resolution image are obtained by alternately performing low-resolution operation and high-resolution operation of an image pickup device; however, the high-resolution image is a mere cutout, and a high-resolution image cannot be obtained for the entire number of the pixels of the device.

The inventions disclosed in Japanese Patent Application Laid-Open Nos. 2005-191813 and 2005-2179704 are described as raising a frame rate and enhancing the quality of images using a plurality of image pickup devices with the same capability. However, the invention disclosed in Japanese Patent Application Laid-Open No. 2005-191813 has a problem in that two identical image pickup devices are required, which simply means that the cost will doubled. Also, the invention disclosed in Japanese Patent Application Laid-Open No. 2005-217970 has a problem in that although a high-frame rate and high-resolution image can be obtained by using both interpolation and interlaced reading, the exposure times of the pixels forming one frame are different, resulting in an unnatural image.

Furthermore, although the inventions disclosed in Japanese Patent Application Laid-Open Nos. 2005-191813 and 2005-217970 are described as raising a frame rate and enhancing the quality of images using a plurality of image pickup devices with the same capability, in the case of digital cameras (video cameras), there are modes not requiring a high frame rate. However, no advantages can be found in the inventions disclosed in Japanese Patent Application Laid-Open Nos. 2005-191813 and 2005-2179704 with regard to such modes.

The present invention has been made in view of such circumstances, and an object of the present invention is to provide a moving image generating apparatus, a moving image shooting apparatus, a moving image generating method and a program, which are capable of providing a moving image with a high-resolution and a high-frame rate, which exceed the capability of an image pickup device. Another object of the present invention is to provide a recording medium which stores computer readable code of the program.

In order to achieve the above object, a moving image generating apparatus according to a first aspect of the present invention comprises: an obtaining device which obtains a series of image data in which high-resolution first image data obtained at a predetermined frame rate and low-resolution second image data obtained at times that are different from the times of the obtainment of the first image data are arranged in a given order; a characteristic point extracting device which extracts characteristic points in the first image data; a corresponding point detecting device which detects corresponding points in the second image data, the corresponding points corresponding to characteristic points in first image data obtained immediately before the second image data; and a generating device which generates high-resolution image data having a content that is the same as that of the second image data by modifying the first image data based on the relationship between the characteristic points extracted by the characteristic point extracting device and the corresponding points detected by the corresponding point detecting device.

In the moving image generating apparatus according to the first aspect, high-resolution first image data obtained at a predetermined frame rate is modified based on characteristic points in the high-resolution first image data and corresponding points in low-resolution second image data obtained at a time that is different from the time of the obtainment of the first image data, thereby generating high-resolution image data having the same content as that of the second image data. A high-resolution moving image with a frame higher than the predetermined frame rate can be obtained by generating high-resolution image data for all the second image data. The corresponding points in the second image data mean points corresponding to the characteristic points extracted in the first image data. Consequently, when performing interpolation between a plurality of high-resolution images, movement of subjects is detected from a low-resolution image, and interpolation is performed based on the detected movement, and thus, a high-resolution image correctly reflecting the movement of the subjects can be generated. Also, since low-resolution image data is used only for detection of a subject and is not used directly for a moving image, low resolution can be provided to the low-resolution image data.

A moving image generating apparatus according to a second aspect of the present invention provides the moving image generating apparatus according to the first aspect, further comprising a resolution converting device which converts the resolution of the first image data to a resolution that is the same as the resolution of the second image data, wherein the characteristic point extracting device extracts characteristic points in the first image data whose resolution has been converted by the resolution converting device.

In the moving image generating apparatus according to the second aspect, the resolution of the first image data is converted to a resolution that is the same as the resolution of the second image data, and characteristic points in the first image data whose resolution has been converted is extracted. Consequently, the corresponding points can correctly be detected.

A moving image generating apparatus according to a third aspect of the present invention provides the moving image generating apparatus according to the second aspect, further comprising a coordinate converting device which converts coordinates of the characteristic points extracted by the characteristic point extracting device and the corresponding points detected by the corresponding point detecting device so as to conform to the resolution of the first image data, wherein the generating device modifies the first image data so that the characteristic points in the first image data whose coordinates have been converted by the coordinate converting device match the corresponding points whose coordinates have been converted by the coordinate converting device.

The moving image generating apparatus according to the third aspect, when the first image data is modified so as to conform to the content of the second image data, the coordinates of the characteristic points extracted in the first image data whose resolution has been converted are converted so as to conform to the first image data, and the first image data is modified so that these characteristic points match the corresponding points whose coordinates have been converted so as to conform the first image data. Consequently, high-resolution image data having the same content as that of the low-resolution second image data can be generated from the first image data.

A moving image generating apparatus according to a fourth aspect of the present invention provides the moving image generating apparatus according to any of the first to third aspects, further comprising a region dividing device which divides the first image data into a plurality of regions by connecting the characteristic points extracted by the characteristic point extracting device, wherein the generating device modifies the characteristic points extracted by the characteristic point extracting device so as to conform to the corresponding points detected by the corresponding point detecting device, and modifies the regions obtained as a result of the division by the region dividing device.

In the moving image generating apparatus according to the fourth aspect, the first image data is divided into a plurality of regions by connecting the characteristic points extracted by the characteristic point extracting device, and the regions are modified so as to conform to the conformation of the characteristic points to the corresponding points. Consequently, high-resolution image data having the same content as that of the low-resolution second image data can be generated from the first image data.

A moving image shooting apparatus according to a fifth aspect of the present invention comprises: the moving image generating apparatus according to any of the first to fourth aspects; an image pickup device capable of performing high-resolution and low-frame rate operation and low-resolution and high-frame rate operation in a given manner; an image pickup controlling device which makes the obtaining device obtain the series of image data in which the first image data and the second image data are arranged in a given order, by controlling the high-resolution and low-frame rate operation and the low-resolution and high-frame rate operation of the image pickup device; and a reproducing device which reproduces a moving image generated by the generating device.

In the moving image shooting apparatus according to the fifth aspect, the series of image data in which the first image data and the second image data are arranged in a given order is obtained by controlling an image pickup device capable of performing high resolution (reading of all the pixels) and low-frame rate operation and low-resolution (reading of a part of the pixels) and high-frame rate operation in a given manner. As described above, as a result of using both operation for reading all the pixels and operation for reading a part of the pixels, a moving image with a resolution for reading all the pixels and with a frame rate exceeding the capability of the image pickup device can be obtained. Also, as result of lowering the resolution during the operation for reading a part of the pixels, the power consumption can be reduced.

A moving image shooting apparatus according to a sixth aspect of the present invention provides the moving image shooting apparatus according to the fifth aspect, wherein the generating device generates high-resolution image data as an interpolation between the high-frame rate first image data and the generated high-resolution image data, in order to obtain successive high-frame rate and high-resolution image data. Consequently, even when image data is not obtained at a fixed frame rate, a high-resolution and fixed-frame rate moving image can be generated.

A moving image shooting apparatus according to a seventh aspect of the present invention comprises: the moving image generating apparatus according to any of the first to fourth aspects; a first image pickup device which obtains the first image data; a second image pickup device which obtains the second image data; a switching device which switches an optical path so that light from a subject enters the first image pickup device or the second image pickup device; and an image pickup controlling device which makes the obtaining device obtain the series of image data in which the first image data and the second image data are arranged in a given order, by controlling the first image pickup device, the second image pickup device and the switching device.

In the moving image shooting apparatus according to the seventh aspect, the series of image data in which the first image data and the second image data are arranged in a given order is obtained by controlling a first image pickup device which obtains the first image data, a second image pickup device which obtains the second image data, and a switching device which switches an optical path so that light from a subject enters the first image pickup device or the second image pickup device. As described above, as a result of combining a plurality of image pickup devices, a moving image with the number of pixels that is the maximum capability of the image pickup device and with a frame rate exceeding the capability of the image pickup device can be obtained. Also, low frame rate can be provided to the frame rate of each image pickup device, and the resolution of the image pickup device which obtains low-resolution image data can be lowered, enabling reduction of the costs. Furthermore, since the resolution of the image pickup device which obtains low-resolution image data can be lowered, the power consumption can be reduced.

A moving image generating apparatus according to an eighth aspect of the present invention comprises: an obtaining device which obtains image data for respective three primary colors in turn at a same frame rate and at different timings; a characteristic point extracting device which extracts characteristic points in image data of an attention frame from among the image data obtained by the obtaining device; a corresponding point extracting device which extracts corresponding points in image data for a color that is the same as the color of the image data of the attention frame, the image data being obtained at a timing closest to the timing of the obtainment of the image data of the attention frame, the corresponding points corresponding to the characteristic points in the image data of the attention frame extracted by the characteristic point extracting device; an estimating device which estimates corresponding points in image data for colors that are different from the color of the image data of the attention frame, the image data being adjacent to the image data of the attention frame, based on the distances between the characteristic points extracted by the characteristic point extracting device and the corresponding points extracted by the corresponding point extracting device, and the timings of the obtainment of the image data by the obtaining device; a first generating device which generates image data for a time that is the same as the time of the obtainment of the image data of the attention frame and for colors that are different from the color of the image data of the attention frame, by modifying the image data for colors that are different from the color of the image data of the attention frame, the image data being adjacent to the image data of the attention frame, based on the characteristic points extracted by the characteristic point extracting device and the corresponding points estimated by the estimating device; and a second generating device which generates image data including three primary colors for image data for the attention frame, by combining the image data of the attention frame, and the image data for a time that is the same as the time of the obtainment of the image data of the attention frame and for colors that are different from the color of the image data of the attention frame, which have been generated by the first generating device.

In the moving image generating apparatus according to the eighth aspect, image data for respective three primary colors obtained in turn at a same frame rate and at different timings are obtained, and characteristic points in image data of an attention frame from among the image data are extracted. Corresponding points in image data for a color that is the same as the color of the image data of the attention frame, the image data being obtained at a timing closest to the timing of the obtainment of the image data of the attention frame, the corresponding points corresponding to the characteristic points in the image data of the attention frame extracted by the characteristic point extracting device, are extracted, and corresponding points in image data adjacent to the image data of the attention frame, the corresponding points corresponding to the characteristic points in the image data of the attention frame, are estimated based on the distances between the extracted characteristic points and corresponding points, and the timings of the obtainment of the image data. Image data for a time that is the same as the time of the obtainment of the image data of the attention frame and for colors that are different from the color of the image data of the attention frame are generated by modifying the image data adjacent to the image data of the attention frame based on the extracted characteristic points and the estimated corresponding points. Image data including three primary colors for image data for the attention frame is generated by combining the generated image data for a time that is the same as the time of the obtainment of the image data of the attention frame and for colors that are different from the color of the image data of the attention frame, and the image data of the attention frame. As described above, the relevant processing is performed for all the obtained image data, enabling provision of a color moving image with a high frame rate three times the frame rate for obtaining image data for a single color. Also, as a result of extracting corresponding points in image data for a color that is the same as the color of the image data whose characteristic points have been extracted, the corresponding points can correctly be extracted. Also, use of temporal interpolation enables easy estimation of corresponding points in image data for other colors.

A moving image generating apparatus according to a ninth aspect of the present invention provides the moving image generating apparatus according to the seventh aspect, further comprising a setting device which, upon obtainment of image data of seven frames by the obtaining device, sets image data obtained three frames before image data of a lastly-obtained frame to be the image data of the attention frame Consequently, an image using all of image data for respective three primary colors can be generated.

A moving image generating apparatus according to a tenth aspect of the present invention provides the moving image generating apparatus according to the eighth or ninth aspect, further comprising a region dividing device which divides the image data adjacent to the image data of the attention frame into a plurality of regions by connecting the corresponding points estimated by the estimating device, wherein the first generating device modifies the regions obtained as a result of the division by the region dividing device, so as to conform to the matching of the corresponding points estimated by the estimating device to the characteristic points extracted by the characteristic point extracting device. Consequently, image data that is different from the image data of the attention frame only in terms of color can be generated from the image data of the attention frame.

A moving image generating apparatus according to an eleventh aspect of the present invention comprises: an obtaining device which obtains image data for respective three primary colors in turn at a same frame rate and at different timings; a characteristic point extracting device which extracts a characteristic point in image data for a color that is different from the color of image data of an attention frame from among the image data obtained by the obtaining device, the image data being obtained at a timing closest to the timing of the obtainment of the image data of the attention frame; a corresponding point extracting device which extracts a corresponding point in image data for a color that is the same as the color of the image data whose characteristic point has been extracted, which is obtained at a timing closest to the obtainment of the image data whose characteristic point has been extracted, with the timing of the obtainment of the attention frame between the timing of the obtainment of the image data whose characteristic point has been extracted and the timing of the obtainment of the image data, the corresponding point corresponding to the characteristic point extracted by the characteristic point extracting device; an estimating device which estimates corresponding points in image data for a time that is the same as the time of the obtainment of the attention frame and for colors that are different from the color of the attention frame, based on the distance between the characteristic point extracted by the characteristic point extracting device and the corresponding point extracted by the corresponding point extracting device, and the timings of the obtainment of the image data by the obtaining device; a first generating device which generates the image data for a time that is the same as the time of the obtainment of the image data of the attention frame and for colors that are different from the color of the image data of the attention frame, by modifying the image data whose characteristic point has been extracted by the characteristic point extracting device, based on the characteristic point extracted by the characteristic point extracting device and the corresponding points estimated by the estimating device, or modifying the image data whose corresponding point has been extracted by the corresponding point extracting device, based on the corresponding point extracted by the corresponding point extracting device and the corresponding points estimated by the estimating device; and a second generating device which generates image data including three primary colors for image data for the attention frame, by combining the image data of the attention frame and the image data for a time that is the same as the time of the obtainment of the image data of the attention frame and for colors that are different from the color of the image data of the attention frame, which have been generated by the first generating device.

In the moving image generating apparatus according to the eleventh aspect, image data for respective three primary colors obtained in turn at the same frame rate and at different timings are obtained, and a desired image from among the image data is determined to be an attention frame. A characteristic point in image data for a color that is different from the color of image data of the attention frame, the image data being obtained at a timing closest to the timing of the obtainment of the image data of the attention frame, is extracted, and a corresponding point in image data for a color that is the same as the color of the image data whose characteristic point has been extracted, which is obtained at a timing closest to the timing of the obtainment of the image data whose characteristic point has been extracted, with the timing of the obtainment of the attention frame between the timing of the obtainment of the image data whose characteristic point has been extracted and the timing of the obtainment of the image data, the corresponding point corresponding to the extracted characteristic point, is extracted, and a corresponding point in the image data of the attention frame is estimated based on the distance between the extracted characteristic point and corresponding point, and the timings of the obtainment of the image data. Image data for a time that is the same as the time of the obtainment of the image data of the attention frame and for colors that are different from the color of the attention frame are generated by modifying the image data whose characteristic point has been extracted, based on the extracted characteristic point and the estimated corresponding point. Alternatively, image data for a time that is the same as the time of the obtainment of the image data of the attention frame and for colors that are different from the color of the image data of the attention frame are generated by modifying the image data whose corresponding point has been extracted by the corresponding point extracting device, based on the extracted corresponding point and the estimated corresponding point. Image data including three primary colors for image data for the attention frame is generated by combining the generated image data for a time that is the same as the time of the obtainment of the image data of the attention frame and for colors that are different from the color of the image data of the attention frame, and the image data of the attention frame. Consequently, a color moving image with a high frame rate three times the frame rate for obtaining image data for a single color can be provided.

A moving image shooting apparatus according to a twelfth aspect of the present invention comprises: the image generating apparatus according to any of the eighth to eleventh aspects; a plurality of image pickup devices that obtain image data for respective three primary colors; a light dividing device which divides light from a subject and makes the light enter the plurality of image pickup devices; an image pickup controlling device which makes the obtaining device obtain the image data for respective three primary colors, which have been obtained in turn at a same frame rate and at different timings, by performing exposures of the plurality of image pickup devices in turn at times shifted from each other; and a reproducing device which reproduces a moving image generated by the second generating device.

In the moving image shooting apparatus according to the twelfth aspect, image data for respective three primary colors obtained in turn at the same frame rate and at different timings are obtained by making light from a subject enter a plurality of image pickup devices that obtain image data for respective three primary colors and performing exposure of the plurality of image pickup devices in turn at times shifted from each other. As described above, as a result of combining plural image pickup devices each including a single-color filter, the apparatus can be used as a camera with excellent color reproducibility, which does not cause false colors in principle, in normal mode, and a high-resolution color moving image can be obtained in high-frame rate mode. Furthermore, the frame rate of each image pickup device can be made to a low frame rate, enabling reduction of the costs.

A moving image generating method according to a thirteenth aspect of the present invention comprises the steps of: (a) obtaining a series of image data in which high-resolution first image data obtained at a predetermined frame rate and low-resolution second image data obtained at times that are different from the times of the obtainment of the first image data are arranged in a given order; (b) extracting a characteristic point in the first image data; (c) detecting a corresponding point in the second image data, the corresponding point corresponding to a characteristic point in first image data obtained immediately before the second image data; (d) generating high-resolution image data having a content that is the same as that of the second image data by modifying the first image data based on the extracted characteristic point and the detected corresponding point; and (e) performing steps (b) to (d) for all the second image data obtained at step (a). A moving image generating method according to a fourteenth aspect of the present invention comprises the steps of: (a) obtaining image data for respective three primary colors obtained in tun at a same frame rate and at different timings; (b) extracting a characteristic point in image data of an attention frame from among the obtained image data; (c) extracting a corresponding point in image data for a color that is the same as the color of the image data of the attention frame, the image data being obtained at a timing closest to the timing of the obtainment of the image data of the attention frame, the corresponding point corresponding to the extracted characteristic point in the image data of the attention frame; (d) estimating corresponding points in image data for colors that are different from the color of the image data of the attention frame, the image data being adjacent to the image data of the attention frame, based on the distance between the characteristic point in the image data of the attention frame, which has been extracted at step (b), and the corresponding point in the image data for a color that is the same as the color of the image data of the attention frame, the image data being obtained at a timing closest to the timing of the obtainment of the image data of the attention frame, which has been extracted at step (c), and the timings of the obtainment of the image data at step (a); (e) generating image data for a time that is the same as the time of the obtainment of the attention frame and for colors that are different from the color of the attention frame, by modifying the image data adjacent to the image data of the attention frame based on the obtained characteristic point and the estimated corresponding point; (f) generating image data including three primary colors for image data for the attention frame, by combining the image data of the attention frame, and the generated image data for a time that is the same as the time of the obtainment of the attention frame and for colors that are different from the color of the attention frame; and (g) performing steps (b) to (f) for all the image data obtained at step (a).

A program according to a fifteenth aspect of the present invention, the program making an arithmetic device execute the moving image generating method according to the thirteenth aspect or fourteenth aspect. In the fifteenth aspect, the arithmetic device includes a CPU of electronic device such as digital camera, a computer and the like.

In order to achieve the above object, a sixteenth aspect of the present invention provides a recording medium which stores computer readable code of the program according to the fifteenth aspect. Floppy Disk, CD (compact disk), DVD disk, hard disk unit various kinds of semiconductor memory and the like can be adopted as “the recording medium” in the aspect.

The present invention enables provision of a moving image with a high-resolution and a high-frame rate, which exceed the capability of an image pickup device.

### BRIEF DESCRIPTION OF THE DRAWINGS

FIG. 1 is a front perspective view illustrating an outer appearance of a first embodiment of a digital camera to which the present invention has been applied;

FIG. 2 is a back perspective view illustrating an outer appearance of the digital camera;

FIG. 3 is a block diagram illustrating an electrical configuration of the digital camera;

FIG. 4 is a diagram schematically illustrating timings for driving an image pickup device;

FIG. 5 is a diagram schematically illustrating timings for driving an image pickup device;

FIG. 6 is a diagram illustrating processing for modifying image data;

FIG. 7 is a flowchart illustrating the flow of processing for generating a high-resolution image;

FIG. 8 is a diagram schematically illustrating drive timings for a generated high-resolution and high-frame rate moving image;

FIG. 9 is a diagram schematically illustrating another type of drive timings for a generated high-resolution and high-frame rate moving image;

FIG. 10 is a block diagram illustrating an electrical configuration of a second embodiment of a digital camera to which the present invention has been applied;

FIG. 11 is a diagram schematically illustrating timings for driving an image pickup device: (a) part in FIG. 11 illustrates timings for driving an image pickup device which shoots high-resolution images; and (b) part in FIG. 11 illustrates timings for driving an image pickup device which shoots low-resolution images;

FIG. 12 is a diagram schematically illustrating drive timings for a generated high-resolution and high-frame rate moving image;

FIG. 13 is a block diagram illustrating an electric configuration of a third embodiment of a digital camera to which the present invention has been applied;

FIG. 14 is a diagram schematically illustrating timings for driving an image pickup device;

FIG. 15 is a flowchart illustrating the flow of processing for generating image data including three primary colors;

FIG. 16 is a diagram illustrating processing for generating image data including three primary colors;

FIG. 17 is a diagram illustrating processing for generating image data including three primary colors; and

FIG. 18 is a diagram schematically illustrating drive timings for a generated high-frame rate moving image.

### DETAILED DESCRIPTION OF THE PREFERRED EMBODIMENTS

Hereinafter, the best mode for providing a moving image shooting apparatus (digital camera) according to the present invention will be described in details with reference to the accompanying drawings.

### First Embodiment

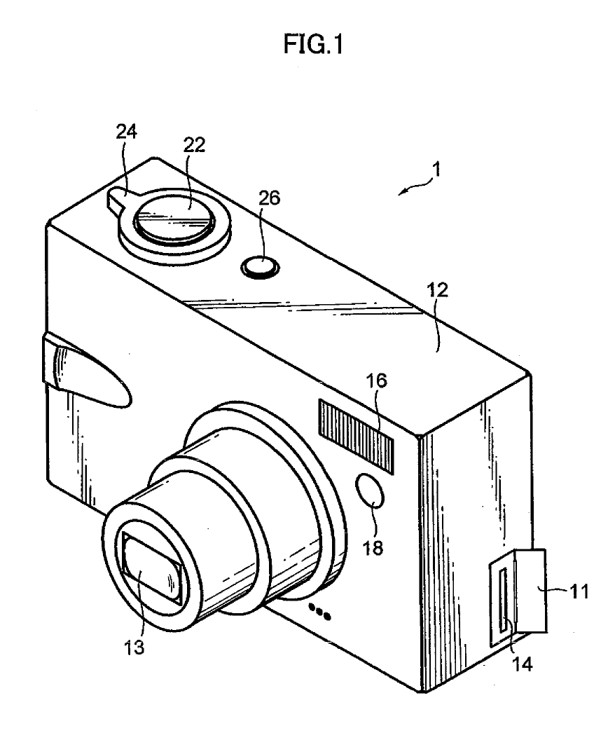

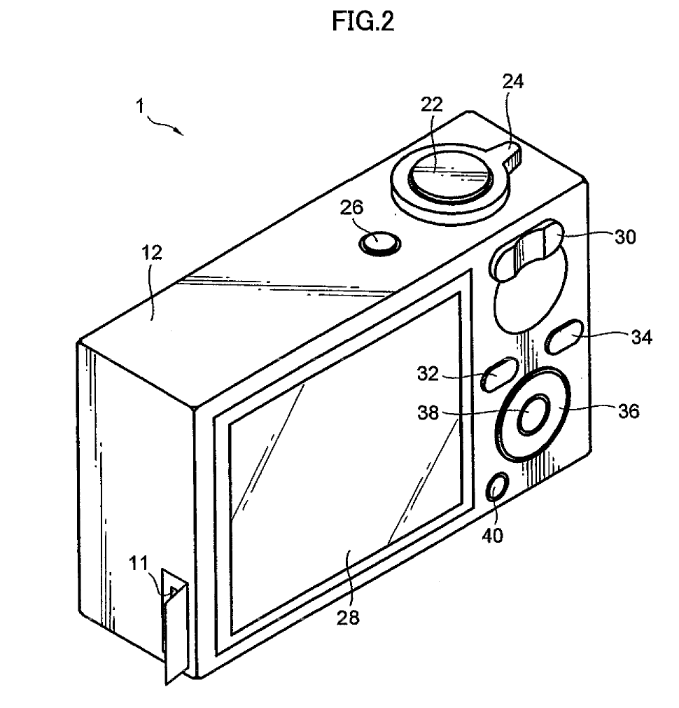

FIG. 1 is a front perspective view illustrating an electronic apparatus according to an embodiment of the present invention, and FIG. 2 is a back perspective view of the same. This electronic apparatus is a digital camera that receives light that has penetrated a lens by means of an image pickup device, converts it into digital signals and records them in a recording medium.

The camera body 12 of a digital camera 1 is formed in the shape of a horizontally-long rectangular box, and the front face thereof, as shown in FIG. 1, is provided with a shooting lens 13, a flashbulb 16, an AF fill light lamp 18, etc., and the top face thereof is provided with a shutter button 22, a mode lever 24, a power button 26, etc. Also, side faces thereof are provided with a USB connector 15 and an openable/closable slot cover 11. The inside of the slot cover 11 is provided with a memory card slot 14 for loading a memory card.

Meanwhile, the back face of the camera body 12, as shown in FIG. 2, is provided with a monitor 28, a zoom button 30, a reproduction button 32, a function button 34, a 20 crosshair button 36, a MENU/OK button 38, a DISP/BACK button 40, etc.

The bottom surface (not shown) is provided with a tripod socket hole and an openable/closable battery cover for accommodating a battery inside.

The lens 13 is included in a collapsible zoom lens barrel, and the zoom lens barrel is moved forward from the camera body 12 by turning the power of the digital camera 1 on via the power button 26. The zooming mechanism and collapsible mechanism of the lens 13 are known, and therefore, the description of the specific configurations thereof will be omitted here.

The memory card slot 14 is a connection part for loading a memory card in which various kinds of data, such as data for images taken of subjects and audio sounds, and firmware are recorded.

The USB connector 15 is a connection part for connecting a USB cable for conveying signals between the digital camera 1 and an external device such as a personal computer or a printer.

The flashbulb 16 uses, for example, a xenon tube as a light source, and is configured so that the amount of light emission thereof can be adjusted. Instead of a flashbulb using a xenon tube, a flashbulb using a high-intensity LED as a light source can be used.

The AF fill light lamp 18 is formed of, for example, a high-intensity LED, and emits light as necessary during AF.

The shutter button 22 is formed of a two-step stroke-type switch: what are called “half press” and “full press”. The digital camera 1, upon this shutter button 22 being pressed halfway, performs shooting preparation processing, that is, AE (automatic exposure), AF (automatic focusing) and AWB (automatic white balancing), and upon the shutter button 22 being fully pressed, performs processing for shooting and recording an image.

The mode lever 24 functions as a shooting mode setting device which sets the shooting mode of the digital camera 1, and the shooting mode of the digital camera 1 is set to various modes according to the position where this mode dial is set. Examples of the modes include: an “automatic shooting mode” in which the aperture, the shutter speed, etc., are automatically set by the digital camera 1, an “moving image shooting mode” for moving image shooting, an “personal image shooting mode” suitable for shooting images of persons, a “sport image shooting mode” suitable for shooting images of moving objects, a “landscape image shooting mode” suitable for shooting images of landscape, a “night-scene image shooting mode” suitable for shooting images of evening and night scenes, an “aperture-priority shooting mode” in which a shooter sets the position on the scale of the aperture and the shutter speed is automatically set by the digital camera 1, a “shutter speed-priority shooting mode” in which a shooter sets the shutter speed and the position on the scale of the aperture is automatically set by the digital camera 1, and a “manual shooting mode” in which a shooter sets the aperture, the shutter speed, etc.

The power button 26 is used for turning the power of the digital camera 1 on/off: the power of the digital camera 1 is turned on/off by means of the power button 26 being pressed for a predetermined period of time (for example, two seconds).

The monitor 28 is formed of a liquid-crystal display that can provide color display. This monitor 28 is used as an image display panel for displaying an image that have previously been taken, during reproduction mode, and also used for a user interface display panel for configuring various settings. Also, during shooting mode, the monitor 28 displays a through-the-lens image as necessary, and thus, is used as an electronic finder for field angle confirmation.

The zoom button 30 is used for a zooming operation for the shooting lens 13 and includes a zoom-tele button for giving an instruction to zoom to a telescopic view side, and a zoom wide angle button for giving an instruction to zoom to a wider angle.

The reproduction button 32 is used for giving an instruction to switch the mode to reproduction mode. In other words, upon the reproduction button 32 being pressed during shooting, the mode of the digital camera 1 is switched to production mode. Also, upon the reproduction button 32 being pressed in a state in which the power is off, the digital camera 1 starts up in reproduction mode.

The function button 34 is used for calling a screen for various settings of shooting and reproduction functions. In other words, upon the function button 34 being pressed during shooting, a screen for setting the image size (the number of recorded pixels), the sensitivity, etc., are displayed on the monitor 28, and upon the function button 34 being pressed during reproduction, for example, a setting screen for deleting an image or requesting printing (digital print order format) is displayed on the monitor 28.

The crosshair button 36 functions as a direction instructing device for inputting instructions for movements in four directions: upward, downward, rightward and leftward directions, and for example, is used for, e.g., selecting a menu item on a menu screen. The MENU/OK button 38 functions as a button (MENU button) for giving an instruction to transit from the regular screen of each mode to the menu screen, and also functions as a button (OK button) for, e.g., determining the selection or executing processing.

The DISP/BACK button 40 is used for giving an instruction to switch the content displayed on the monitor 28 (DISP function), and also used for giving an instruction to, e.g., cancel an input (BACK function). The function assigned to the DISP/BACK button 40 is switched according to the settings of the digital camera 1.

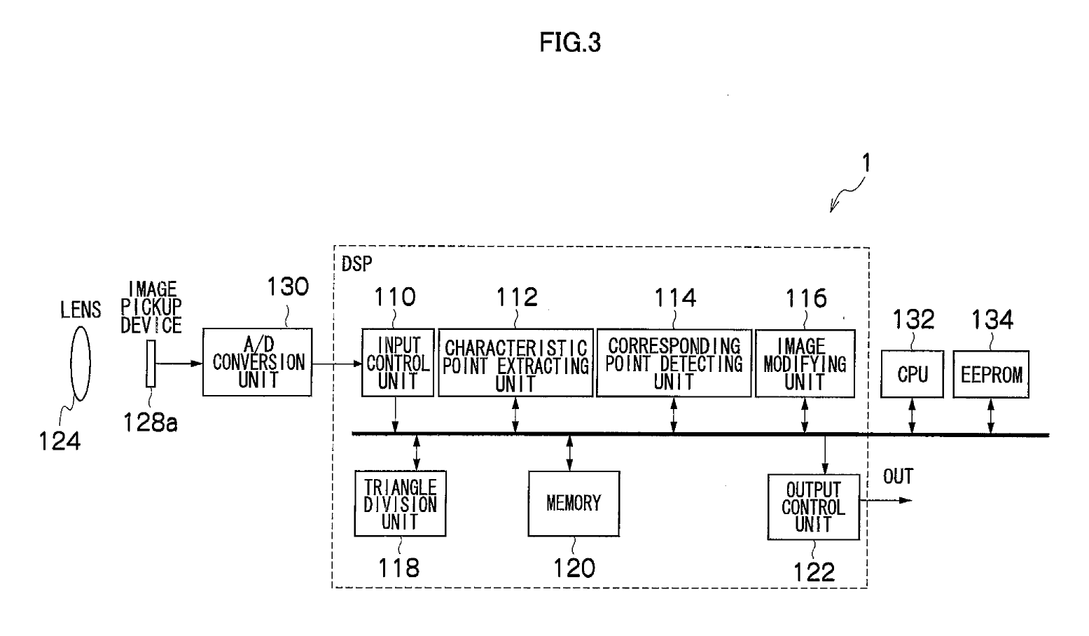

FIG. 3 is a block diagram illustrating the electrical configuration of the digital camera 1 according the present embodiment.

As shown in the figure, the digital camera 1 mainly includes, e.g., an input control unit 110, a characteristic point extracting unit 112, a corresponding point detecting unit 114, an image modifying unit 116, a triangle division unit 118, a memory 120, an output control unit 122, a shooting optical system 124, an image pickup device 128a, an A/D conversion unit 130, a CPU 132, and an EEPROM 134.

The shooting optical system 124 includes the shooting lens 13, an aperture and a shutter, and each of the elements operates as a result of being driven by a driving unit formed of an actuator such as a motor. For example, a focus lens group constituting the shooting lens 13 is moved forward/backward as a result of being driven by a focus motor, and a zoom lens group is moved forward/backward as a result of being driven by a zoom motor. Also, the aperture is widened or narrowed as a result of being driven by an aperture motor, and the shutter is opened or closed as a result of being driven by a shutter motor. The shooting optical system 124 is controlled according to instructions from a CPU 132 via a driving unit (not shown).

The image pickup device 128a is formed of, e.g., a color CCD with a predetermined color filter arrangement, and electrically picks up an image of subjects imaged by the shooting optical system 124. The image pickup device 128a is driven based on a timing signal output from a timing generator (TG) according to instructions from the CPU 132.

The image pickup device 128a in the present embodiment is an image pickup device capable of changing the resolution of an image to be read. The image pickup device 129a enables: reading an image with a low resolution by a pixel skipping operation to read charges for only a part of the pixels or image mixing operation to mix charges for signals representing the pixels to reduce the number of pixels; and reading an image with a high resolution by reading all the pixels. When reading an image with a low resolution, only a short period of time is required for the reading, and thus, the timing for reading the next image can be advanced, i.e., the frame rate can be raised. A high-resolution image refers to an image having a number of pixels of around 1920×1080, and a low-resolution image refers to an image having a number of pixels of around 640×480.

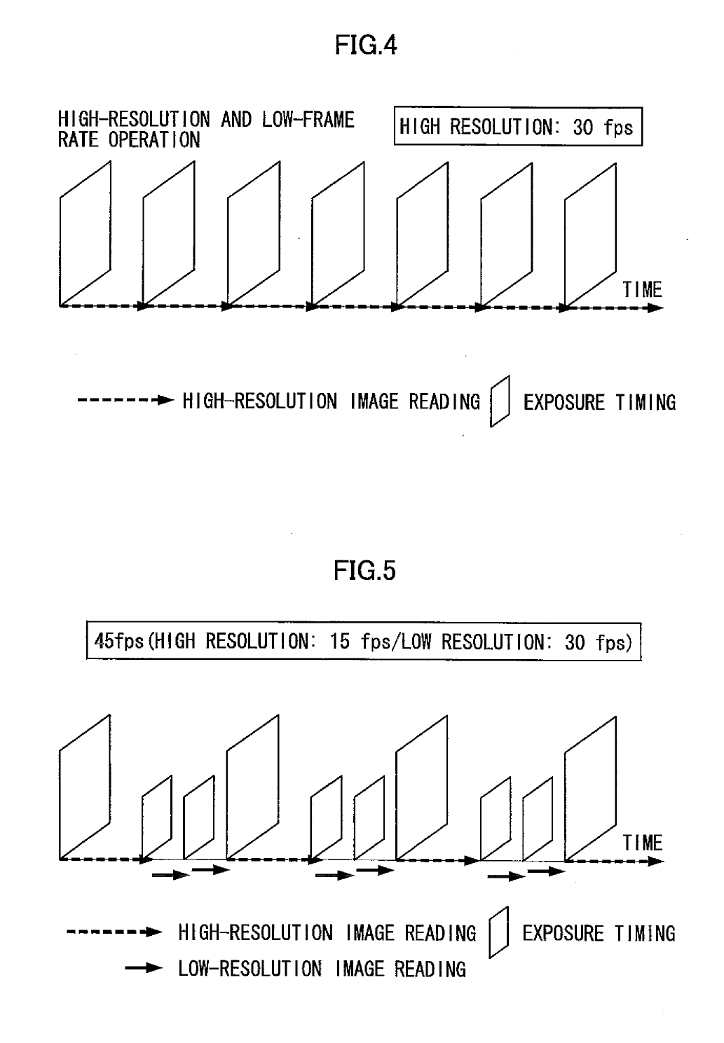

Also, the image pickup device 128a can perform an operation to read all the pixels at a low frame rate and an operation to read only a part of the pixels at a high frame rate in a given order. FIG. 4 is a schematic diagram illustrating the case where high-resolution image data is obtained by an operation to read all the pixels at a low frame rate, and FIG. 5 is a schematic diagram illustrating the case where obtainment of high-resolution image data by means of an operation to read all the pixels at a low frame rate and obtainment of low-resolution image data by means of an operation to read only a part of the pixels at a high frame rate are combined.

As shown in FIG. 4, when all the pixels in the image pickup device 128a are read, 30 fps is the maximum frame rate for reading because of time required for reading the pixels. Meanwhile, when only a part of the pixels is read by pixel skipping, a shorter period of time is required for reading the pixels compared to the case where all the pixels are read, and thus, reading can be performed at a high-frame rate. In the case shown in FIG. 5, low-resolution image data can be read in time around half the time required for reading high-resolution image data. Accordingly, image data can be obtained at a high frame rate of 45 fps by combining high-resolution image data and low-resolution image data.

The A/D conversion unit 130 converts R, G and B analog image signals generated by performing correlated double sampling processing (processing for obtaining more correct image data by figuring out the difference between the levels of the feed-through components and the image signal components contained in an output signal for each pixel of the image pickup device, in order to reducing noise (especially, thermal noise), etc., contained in the output signal) and amplification on image signals output from the image pickup device 128a into digital image signals.

The input control unit 110 includes a line buffer with a predetermined capacity, and performs the following processing on the image signals for one image, which have been output from the A/D conversion unit 130, according to instructions from the CPU 132, and records them in the memory 120.

The input control unit 110 includes, e.g., a synchronization circuit (processing circuit that converts color signals into synchronized signals, by performing interpolation to resolve spatial skews of color signals caused due to the color filter arrangement of the single plate CCD), a white balance correction circuit, a gamma correction circuit, a contour correction circuit, a brightness and color-difference signal generation circuit, and performs necessary signal processing on input image signals according instructions from the CPU 132 to generate image data (YUV data) consisting of brightness data (Y data) and color-difference data (Cr and Cb data).

Also, the input control unit 110 performs processing for compressing the input image data into a predetermined format according to an instruction from the CPU 132 to generate compressed image data. Furthermore, the input control unit 110 performs processing for expanding the input compressed image data into a predetermined format according to an instruction from the CPU 132 to generate non-compressed image data.

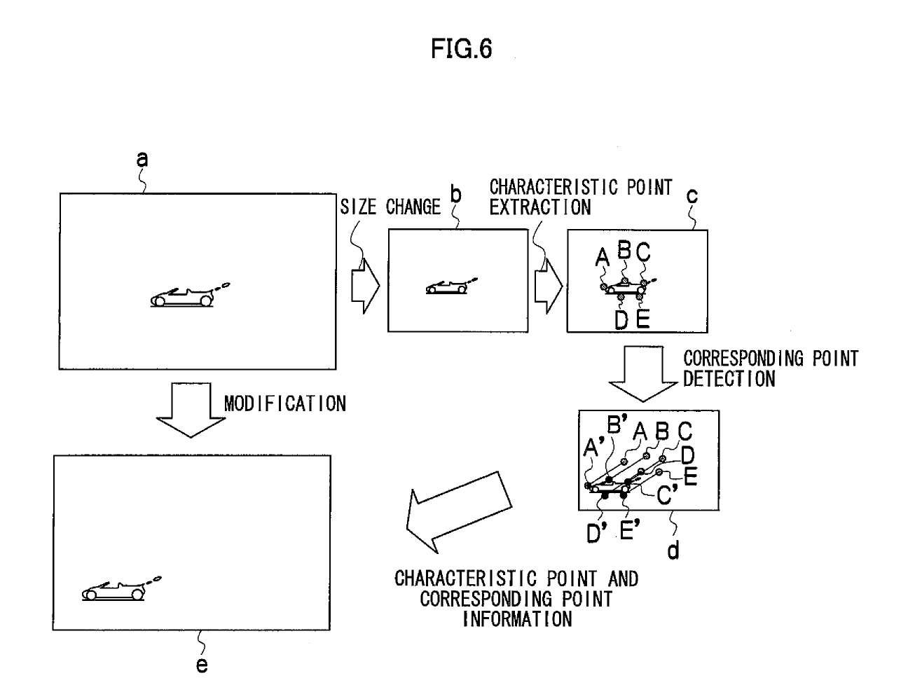

The characteristic point extracting unit 112 extracts characteristic points in high-resolution image data, which is of an image that is the basis for image processing (see (c) in FIG. 6). In order to modify the image in the image modifying unit 116, it is necessary to determine the correspondences of points between images. Therefore, the correspondences of points between image data of plural images are determined by selecting points whose correspondences can easily be determined. These points whose correspondences can easily be determined are characteristic points. For a method for extracting characteristic points from image data, various methods that have already been known can be employed. In the present embodiment, since the correspondences are determined in low-resolution image data, the resolution of high-resolution image data is converted into a low resolution, and characteristic points are extracted from the image data whose resolution has been converted into a low resolution. Subsequently, the data for the characteristic points are input to the corresponding point detecting unit 114.

The corresponding point detecting unit 114 detects corresponding points, which are corresponding points in low-resolution image data and correspond to the characteristic points input from the characteristic point extracting unit 112. The characteristic points extracted by the characteristic point extracting unit 112 and low-resolution image data are input to the corresponding point detecting unit 114. First, the corresponding point detecting unit 114 detects what characteristics the characteristic points of the input image have. Then, the corresponding point detecting unit 114, as shown in (d) in FIG. 6 extracts corresponding points corresponding to the input respective characteristic points, i.e., a corresponding point A′ corresponding to a characteristic point A, a corresponding point B′ corresponding to a characteristic point B, a corresponding point C′ corresponding to characteristic point C, corresponding point D′ corresponding to characteristic point D, and a corresponding point E′ corresponding to a characteristic point E.

The image modifying unit 116 modifies the high-resolution image data so as to conform to the low-resolution image data whose corresponding points have been detected by the corresponding point detecting unit 114.

The triangle division unit 118 divides the high-resolution image data into a plurality of triangle regions by connecting the characteristic points in the high-resolution image data.

The output control unit 122 outputs image data input by the input control unit 110 and the image data modified by the image modifying unit 116 to a media controller, a display control unit, an AE/AWB detection circuit, an AF detection circuit, etc., which are not shown.

The output image data is subjected to various processing in each of these elements controlled by the CPU 132. For example, the media controller performs reading/writing of the data from/to a memory card, and the display control unit converts the data into picture signals (for example, NTSC signals, PAL signals or SECAM signals) for displaying the data on the monitor 28 and output them to the monitor 28.

The CPU 132 controls processing executed in these elements based on the program stored in the EEPROM 134. The EEPROM 134 stores code of the program of the moving image generating method according to the present invention. The program can be installed by downloading it from external devices like PC (personal computer).

Next, an operation of the digital camera 1 according to the present embodiment, which has the above-described configuration, will be described.

First, a shooting and recording operation and a reproduction operation of the digital camera 1 will be described.

Upon power being supplied to the digital camera 1 as a result of the power button 26 being pressed, the digital camera 1 starts up in shooting mode.

First, the driving unit for the shooting optical system 124 is driven to move the shooting lens 13 forward to a predetermined position. Then, when the shooting lens 13 has moved to the predetermined position, a through-the-lens image is picked up by the image pickup device 128a and the through-the-lens image is displayed on the monitor 28. In other words, images are successively picked up by the image pickup device 128a, and the signals for the images are successively processed to generate image data for the through-the-lens image. The generated image data is sequentially converted into a signal format for display, and output to the monitor 28. Consequently, the images picked up by the image pickup device 128a are displayed on the monitor 28 as through-the-lens images.

When shooting a still image, a shooter determines the picture composition by viewing the through-the-lens image displayed on this monitor 28, and presses the shutter button 22 halfway.

Upon the shutter button 22 being pressed halfway, a S1ON signal is input to the CPU 132. The CPU 132 executes shooting preparation processing, i.e., AE, AF and AWB processing in response to this S1ON signal.

First, upon the image signals output from the image pickup device 128a being input to the DSP by means of the input control unit 110, the image data is output from the DSP via the output control unit 122, and provided to the AE/AWB detection unit and the AF detection unit.

The AE/AWB detection unit calculates physical quantities required for AF control and AWB control from the input image signals. For example, as a physical quantity required for AE control, the AE/AWB detection unit divides one screen into a plurality of areas (for example, 16×16), and calculates an integrated value of the R, G and B image signals for each of the areas obtained as a result of the division. The CPU 132 detects the brightness of a subject (subject brightness) based on the integrated value obtained from the AE/AWB detection circuit, and calculates an exposure value suitable for shooting (shooting EV value). Then, the CPU determines the aperture value and the shutter speed from the calculated shooting EV value and a predetermined program chart. Also, as a physical quantity required for AWB control, one screen is divided into a plurality of areas (for example, 16×16), and an average integrated value for the image signals of each color of R, C and B is calculated for each of the areas obtained as a result of the division. The CPU 132 calculates the ratios of R/G and B/G for each of the areas, from the obtained integrated value for R, the obtained integrated valve for B and the obtained integrated value for G, and determines the type of the light source based on, e.g., the distribution of the obtained R/G and B/G values in the R/G and B/G color spaces. Then, gain values (white balance correction values) for the R, G and B signals in a white balance adjustment circuit are determined according to white balance adjustment values suitable for the determined light source type so that each ratio value become approximately 1 (i.e., the values of the integrated values of R, G and B in one screen becomes R:G:B≈1:1:1). These physical quantities are output to the CPU 132. The CPU 132 determines the aperture value and the shutter speed based on the output from the AE/AWB detection unit, and determines the white balance correction values.

Concurrently, the AE/AWB detection unit determines whether or not light emission of the flashbulb 16 is necessary, from the detected subject brightness. When it is determined that light emission of the flashbulb 16 is necessary, the AE/AWB detection unit makes the flashbulb 16 preliminarily emit light, and determines the amount of light to be emitted by the flashbulb 16 during actual shooting, based on the reflected light of the preliminary-emitted light.

Also, the AF detection unit calculates a physical quantity required for AF control from the input image signals and output it to the CPU. In the digital camera 1 according to the present embodiment, AF control is performed based on the contrast of the image obtained from the image pickup device 128a (what is called “contrast AF”), that is, the CPU moves the focus lens group from the close focusing position to the infinity focusing position by means of controlling, e.g., the driving unit via predetermined steps, and the AF detection unit obtains focus evaluation values indicating the sharpnesses of the images from the image signals input at the respective positions, and determines the position where the obtained focus evaluation value is the maximum to be the focal position. The CPU 132 controls the movement of the focus lens based on the output from the AF detection unit, and makes the shooting lens 13 focus on a main subject. At this time, the CPU 132 executes AF control with making AF fill light lamp 18 emit light as necessary.

The shooter confirms, e.g., the state of the focus of the shooting lens 13 by viewing the through-the-lens image displayed on the monitor 28 and executes shooting, that is, fully presses the shutter button 22.

Upon the shutter button 22 being fully pressed, a S20N signal is input to the CPU 132. The CPU 132 executes shooting and recording processing in response to the S20N signal.

First, the image pickup device 128a is exposed with the aperture value and shutter speed obtained by the above-described AE processing to pick up an image for recording. The image signals for recording, which are output from the image pickup device 128a, are loaded to the input control unit 110, and the input control unit 110 performs predetermined signal processing on the input image signals to generate image data (YUV data) consisting of brightness data and color-difference data. The generated image data is once stored in the memory 120, and the input control unit 110 performs predetermined compression processing on the generated image data to generate compressed image data.

The compressed image data is stored in the memory 120, and recorded in a memory card via the media controller as a still image file in a predetermined format (for example, Exif). The image data stored in the RAM is stored in a flash ROM as a still image file in a predetermined format (for example, Exif) where the memory card has no free space in which the image file can be stored or where the operator selects to do so. When the image data is stored in the flash ROM, the image data is stored in a plurality of clusters, normally, in a plurality of successive clusters.

When shooting a moving image, a shooter operates the mode lever 24 to set the operation mode of the digital camera 1 to the moving image shooting mode. Then, the shooter determines the picture composition by viewing the through-the-lens image displayed on the monitor 28, and presses the shutter button 22.

Upon the shutter button 22 being pressed, the CPU 132 executes the aforementioned shooting preparation processing, i.e., AE, AF and AWB processing. Subsequently, the CPU successively executes the aforementioned shooting and recording processing. Consequently, moving image shooting and recording in normal mode is performed.

Image data of the still image or the moving image recorded in the memory card or the flash ROM as described above is reproduced and displayed on the monitor 28 by setting the mode of the digital camera 1 to reproduction mode. The transition to reproduction mode is conducted by pressing the reproduction button 32.

Upon the reproduction button 32 being pressed, the CPU 132 reads the compressed image data in the lastly-recorded image file. Where the lastly-recorded image file is recorded in the memory card, the CPU 132 reads the compressed image data in the image file lastly recorded in the memory card, via the media controller. Where the lastly-recorded image file is recorded in the flash ROM, the CPU 132 can read the compressed image data in the image file directly from the flash ROM.

The compressed image data read from the memory card or the flash ROM is provided to a compression and expansion processing unit to make the compressed image data be non-compressed image data and then the non-compressed image data is provided to the memory 120. Then, the data is output from the memory 120 to the monitor 28 via the display control unit. Consequently, the image recorded in the memory card or the flash ROM is reproduced and displayed on the monitor 28.

Frame-by-frame reproduction of an image is performed by operating the right and left keys of the crosshair button 36, and upon the right key being operated, the next image file is read from the memory card and reproduced and displayed on the monitor 28. Also, upon the left key of the crosshair button 36 being operated, the image file one frame before the current image file is read from the memory card or the flash ROM, and reproduced and displayed on the monitor 28.

While confirming the image reproduced and displayed on the monitor 28, the image recorded in the memory card or the flash ROM can be deleted as necessary. The deletion of the image is performed by pressing the function button 34 in a state in which the image is reproduced and displayed on the monitor 28.

Upon the function button 34 being pressed, the CPU 132 makes the monitor 28 display a message to confirm the shooter about the deletion of the image, such as “Delete this photo?”, overlapping the image, via the display control unit. Upon the MENU/OK button 38 being pressed, the deletion of the image is conducted. Where the image data is recorded in the memory card, the CPU 132 deletes the image file recorded in the memory card, via the media controller. Where the image data is recorded in the flash ROM, the CPU 132 can delete the image file directly from the flash ROM.

As described above, the digital camera 1 performs shooting, recording and reproduction of a still image or a moving image.

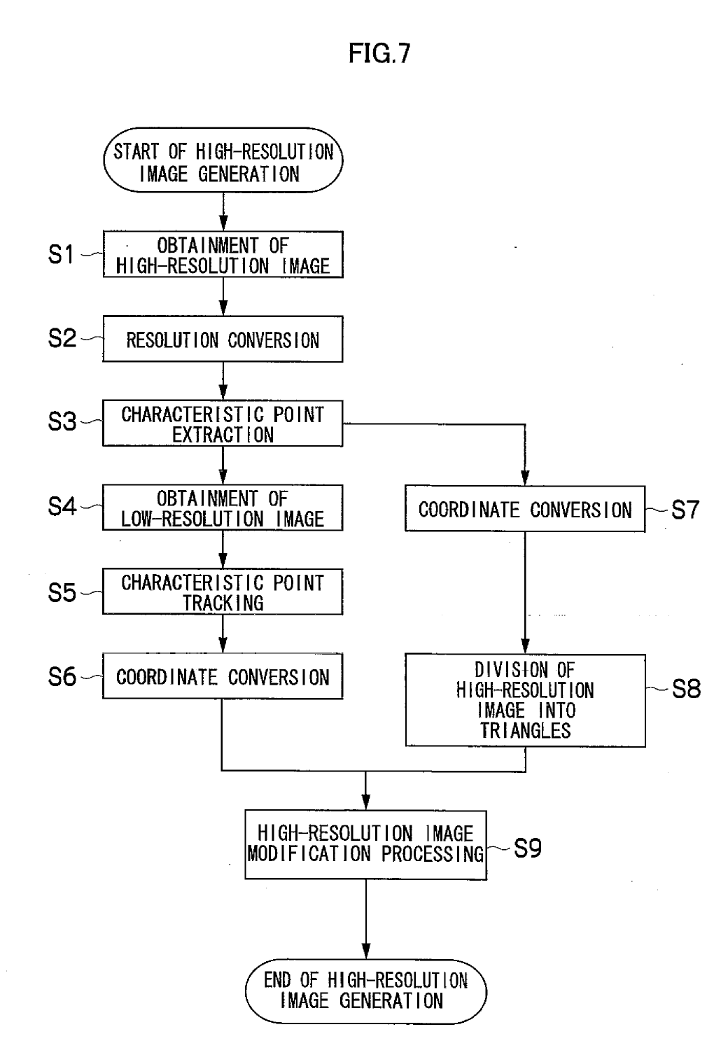

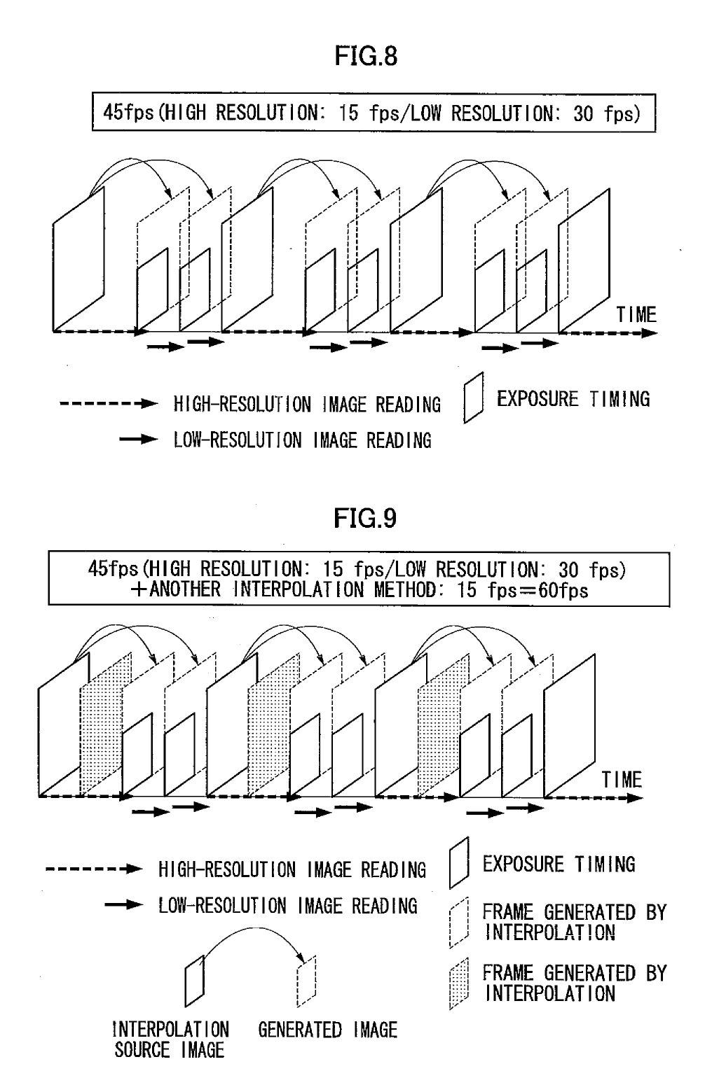

In the present embodiment, there is a moving image shooting mode other than the normal mode, the moving image shooting mode being a high-resolution mode that provides a high-resolution and high-frame rate image. The normal mode is a mode in which a moving image is shot by making the pickup device 128a to operate so as to read all the pixels at a low frame rate (see FIG. 4). Meanwhile, the high-resolution mode is a mode in which the image pickup device 128a is made to perform an operation to read all the pixels at a low frame rate and an operation to read only a part of the pixels at a high frame rate in a given order (see FIG. 5), and high-resolution image data matching the low-resolution image data is generated (see FIG. 7), thereby shooting a high-resolution and high-frame rate moving image (see FIG. 8).

Hereinafter, generation of an image in high resolution mode will be described. FIG. 7 is a flowchart illustrating the flow of processing for generating a high-resolution image having the same content as that of a low-resolution image. The CPU 132 controls, e.g., the characteristic point extracting unit 112, the corresponding point detecting unit 114, the image modifying unit 116, and the triangle division unit 118 according to this flow.

First, the CPU obtains high-resolution image signals from the image pickup device 128a at a timing of an operation to read all the pixel, and after various processing being performed, loads the signals onto the memory 120 as high-resolution image data (high-resolution image) (step S1). Subsequently, the high-resolution image (see (a) in FIG. 6) obtained at step S1 is input to the characteristic point extracting unit 112, and the characteristic point extracting unit 112 converts the resolution of the high-resolution image so that the resolution of the high-resolution image and the resolution of image data obtained when an operation to read only a part of the pixels is performed (low-resolution image) become the same (step S2; see (b) in FIG. 6).

The characteristic point extracting unit 112 extracts characteristic points in the high-resolution image whose resolution has been converted at step S2 (step S3; see (c) in FIG. 6). Information on the characteristic points extracted at step S3 is input to the corresponding point detecting unit 114.

The corresponding point detecting unit 114 obtains a low-resolution image shot at a timing that is different from the timing of the obtainment of the high-resolution image, from the image pickup device 128a, and after various processing being performed, the low-resolution image is loaded to the memory 120 (step S4). The corresponding point detecting unit 114 detects corresponding points corresponding to the characteristic points obtained at step S3, in the low-resolution image loaded at step S4, which has been loaded until the obtainment of the next high-resolution image (step S5; see (d) in FIG. 6). As a result of determining the correspondence between the images with the same resolution, the corresponding points can correctly be detected. Subsequently, the corresponding point detecting unit 114 converts the coordinates of the corresponding points detected at step S5 so as to conform to the high-resolution image (step S6).

The characteristic points extracted at step S3 are input to the corresponding point detecting unit 114, and the coordinates of the characteristic points are converted in the characteristic point extracting unit 112 so as to conform to the high-resolution image (step S7). Then, the high resolution image is divided into a plurality of triangle regions by connecting the characteristic points whose coordinates have been converted so as to conform to the high-resolution image (step S8).

The image modifying unit 116 modifies the high-resolution image so as to conform to the low-resolution image by modifying the respective triangle regions of the high-resolution image obtained as a result of the division at step S8 so as to conform to the triangle regions formed by the corresponding points whose coordinates have been converted at step S6 so as to conform to the high-resolution image (step S9; see (e) in FIG. 6).

Consequently, a high-resolution image at the timing of loading the low-resolution image can be obtained. As illustrated at steps S4 to S9 above, the present embodiment is characterized in that low-resolution images are used only for obtaining information on movements of subjects. As a result of detecting a movement of a subject by means of a low-resolution image as described above, a high-resolution image correctly reflecting the movement of the subject can be generated. Also, a more correct image can be generated as a result of using a high-resolution image immediately before the low-resolution image.

Processing at steps S1 to S9 is performed for all the low-resolution images, all the images become high-resolution images as shown in FIG. 8, enabling provision of a high-resolution and high-frame rate moving image.

According to the present embodiment, a movement of a subject is detected using a low-resolution image, and an image is generated (interpolated) based on the movement of the subject, enabling generation of a high-resolution image correctly reflecting the movement of the subject.

Also, according to the present embodiment, both an operation to read all the pixels and an operation to read a part of the pixels are used, enabling provision of a moving image with a frame rate exceeding the capability of an image pickup device and with a resolution for reading all the pixels.

Furthermore, according to the present embodiment, low-resolution image data is used only for detection a subject, and is not used directly for a moving image, enabling lowering of the resolution of the low-resolution image data. Consequently, the power consumption can be reduced.

In the present embodiment, a high-resolution image at the timing of the obtainment of low-resolution image data is generated. However, as shown in FIG. 8, the time between obtained high-resolution image data and the low-resolution image data obtained next to the high-resolution image data is longer than the time between high-resolution images generated so as to conform to low-resolution image data.

Therefore, as shown in FIG. 9, an image is generated between obtained high-resolution image data, and a high-resolution image generated so as to conform to low-resolution image data obtained next to the high-resolution image data, by, e.g., performing temporal interpolation, enabling provision of a high-resolution moving image with a higher frame rate. The interpolation can be performed using various methods that have already been known. In this case, the time between the interpolation source image data and the interpolated image data is short, not causing the problem of the image being broken due to an error in estimation of a movement of a subject.

Generation of images in high-resolution mode may be performed simultaneously with shooting of a moving image or may also be performed after shooting of a moving image.

### Second Embodiment

Although in the first embodiment of the present invention, high-resolution and low-frame rate image data and low-resolution and high-frame rate image data are obtained by combining an operation of an image pickup device to read all the pixels at a low frame rate and an operation of the image pickup device to read only a part of the pixels at a high frame rate, in a given manner, a method for obtaining high-resolution and low-frame rate image data and low-resolution and high-frame rate image data is not limited to this method.

In a second embodiment of the present invention, high-resolution and low-frame rate image data and low-resolution and high-frame rate image data are obtained using a plurality of image pickup devices. Hereinafter, a digital camera 2 according to the second embodiment of the present invention will be described. The parts that are the same as those of the first embodiment are provided with the same reference numerals, and the description thereof will be omitted.

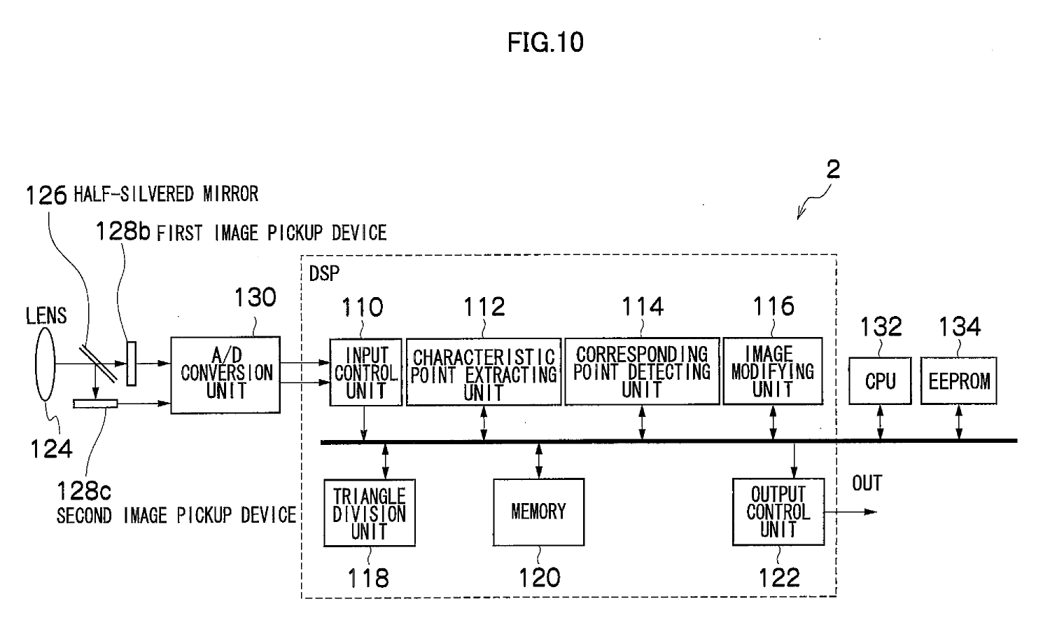

FIG. 10 is a block diagram illustrating the electrical configuration of the digital camera 2 according to the present embodiment.

As shown in the figure, the digital camera 2 mainly includes, e.g., an input control unit 110, a characteristic point extracting unit 112, a corresponding point detecting unit 114, an image modifying unit 116, a triangle division unit 118, a memory 120, an output control unit 122, a shooting optical system 124, a half-silvered mirror 126a, image pickup devices 128b and 128c, an A/D conversion unit 130, a CPU 132, and an EEPROM 134.

The half-silvered mirror 126a divides light from a subject, the light coming in from the shooting optical system 124, and guides the light to the image pickup device 128b and the image pickup device 128c.

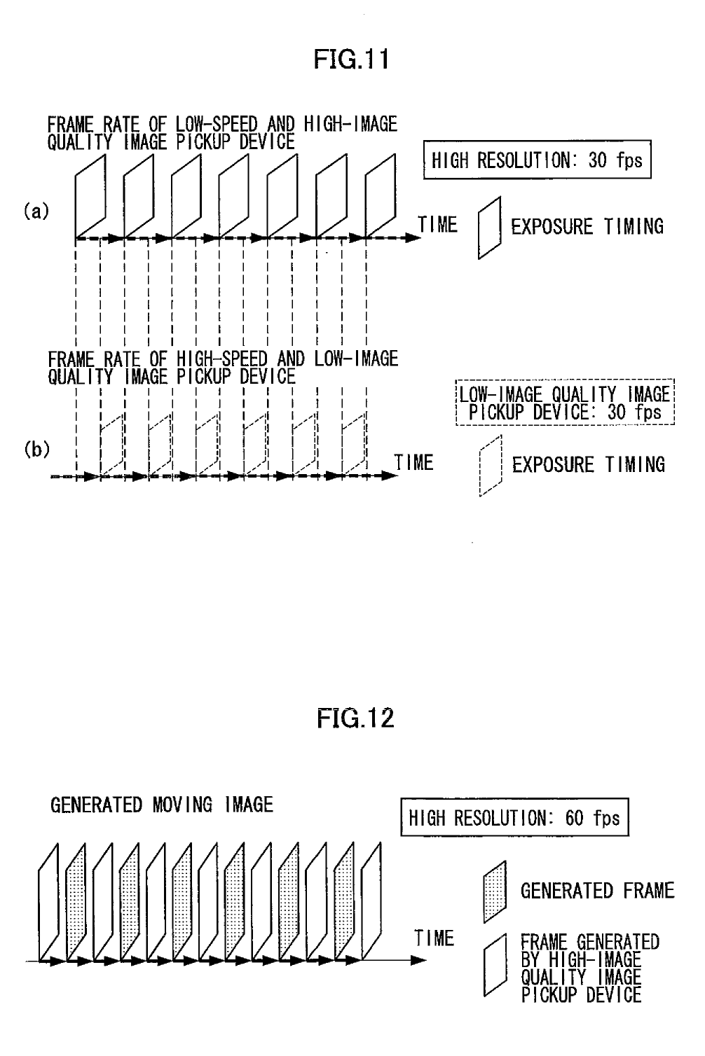

The image pickup device 128b is an image pickup device capable of picking up a high-resolution image of, e.g., 1920×1080 pixels, and as shown in (a) part in FIG. 11, can obtain an image at a frame rate of, e.g., 30 fps.

The image pickup device 128c is an image pickup device which picks up a low-resolution image of, e.g., 640×480 pixels. Although the frame rate of the image pickup device 128c only needs to be a frame rate equal or exceeding the frame rate of the image pickup device 128b, in the present embodiment, as shown in (b) part in FIG. 11, an image is obtained at the same frame rate as that of the image pickup device 128b.

A CPU 132 controls the image pickup device 128b and the image pickup device 128c based on the program stored in the EEPROM 134 so that the image pickup device 128b and the image pickup device 128c operate at different timings. Although in the present embodiment, as shown in FIGS. 11A and 11B, high-resolution image data and low-resolution image data are obtained in turn, a plurality of low-resolution image data may be obtained between high-resolution image data.

The processing at steps S1 to S9 in FIG. 7 is performed on the high-resolution image data and low-resolution image data, which have been obtained as described above, a high-resolution image for the timing of the obtainment of a low-resolution image can be obtained. Then, as a result of performing the processing at steps S1 to S9 on all the low-resolution images, all the images becomes high-resolution images as shown in FIG. 12, and thus, a moving image with a high resolution and a high frame rate of 60 fps can be obtained.

According to the present embodiment, as a result of combining plural image pickup devices, a moving image with a frame rate exceeding the capability of each image pickup device and with the number of pixels that is the maximum capability of each image pickup device can be provided. Also, the frame rate of each image pickup device may be low, enabling reduction of the costs.

Also, according to the present embodiment, low-resolution image data is used only for detecting subjects and not used directly for a moving image, enabling lowering of the resolution required for an image pickup device for obtaining low-resolution image data. Consequently, the power consumption can be reduced, and the costs can also be reduced.

Although in the present embodiment, a moving image with a frame rate of 60 fps is generated because high-resolution image data and low-resolution image data are obtained in turn at a frame rate of 30 fps, respectively, a moving image with a higher frame rate can easily be obtained by changing the frame rate of low-resolution image data.

### Third Embodiment

Although in the first and second embodiments of the present invention, a high-resolution and high-frame rate moving image is obtained by obtaining low-resolution image data and high-resolution image data and generating a high-resolution image having the same content as that of the low-resolution image data, a method for obtaining a high-resolution and high-frame rate moving image is not limited to this method.

In a third embodiment of the present invention, a high-resolution and high-frame rate moving image is obtained by obtaining image data for each color and generating color image data including three primitive colors based on the image data. Hereinafter, a digital camera 3 according to the third embodiment of the present invention will be described. The parts that are the same as those of the first embodiment are provided with the same reference numerals and the description thereof will be omitted.

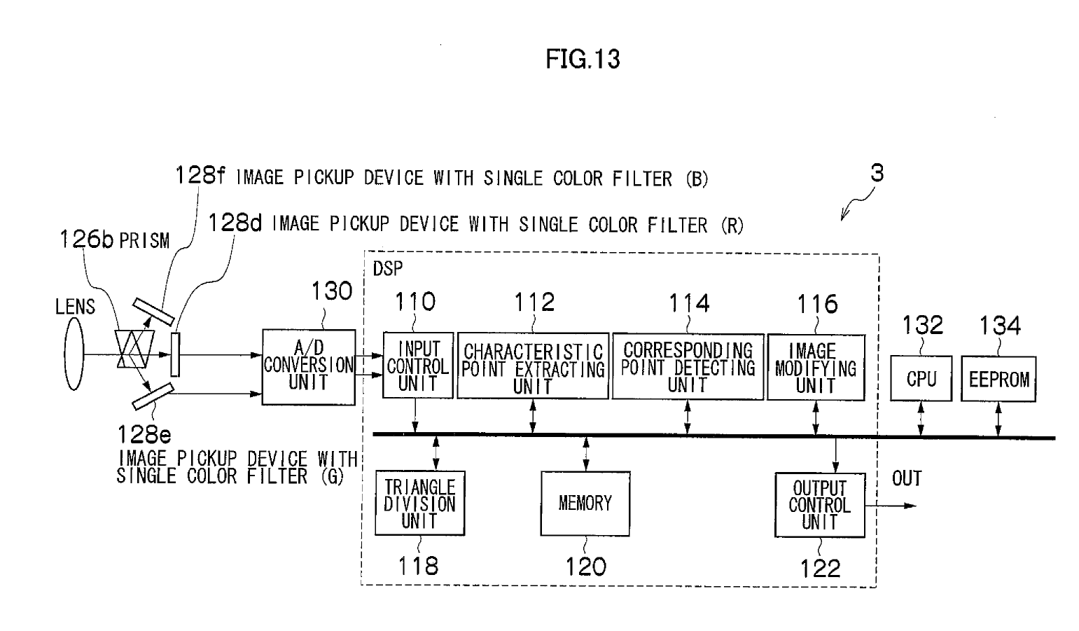

FIG. 13 is a block diagram illustrating the electrical configuration of the digital camera 3 according to the present embodiment.

As shown in the figure, the digital camera 3 mainly includes, e.g., an input control unit 110, a characteristic point extracting unit 112, a corresponding point detecting unit 114, an image modifying unit 116, a triangle division unit 118, a memory 120, an output control unit 122, a shooting optical system 124, a prism 126b, image pickup devices 128d, 128e and 128f, an A/D conversion unit 130, a CPU 132, and an EEPROM 134.

The prism 126b divides light guided by the shooting optical system 124 and guides the light to the image pickup devices 128d, 128e and 128f.

The image pickup device 128d, 128e and 128f are CCD each provided with a color filter of a color (R, G or B) different from each other. In the present embodiment it is assumed that the image pickup device 128d is provided with a red color filter, the image pickup device 128e is provided with a green color filter, and the image pickup device 128f is provided with a blue color filter.

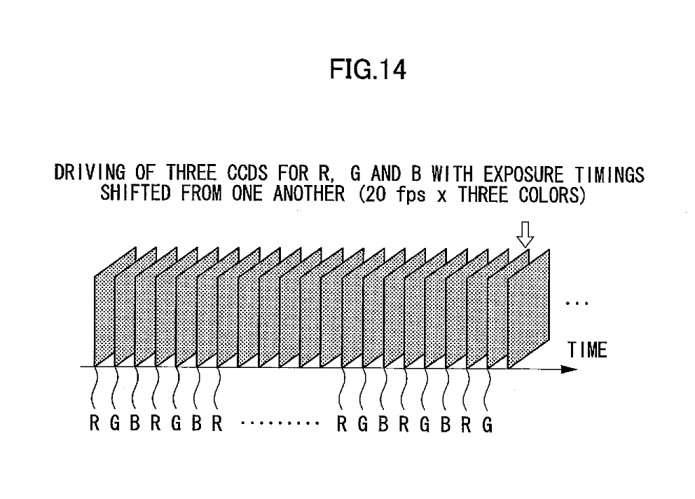

The CPU 132 controls the image pickup devices 128d, 128e and 128f based on the program stored in the EEPROM 134 so that the image pickup devices 128d, 128e and 128f operate at exposure timings that are different from one another. As a result, as shown in FIG. 14, image data for each of R, G and B are obtained at a frame rate of 20 fps.

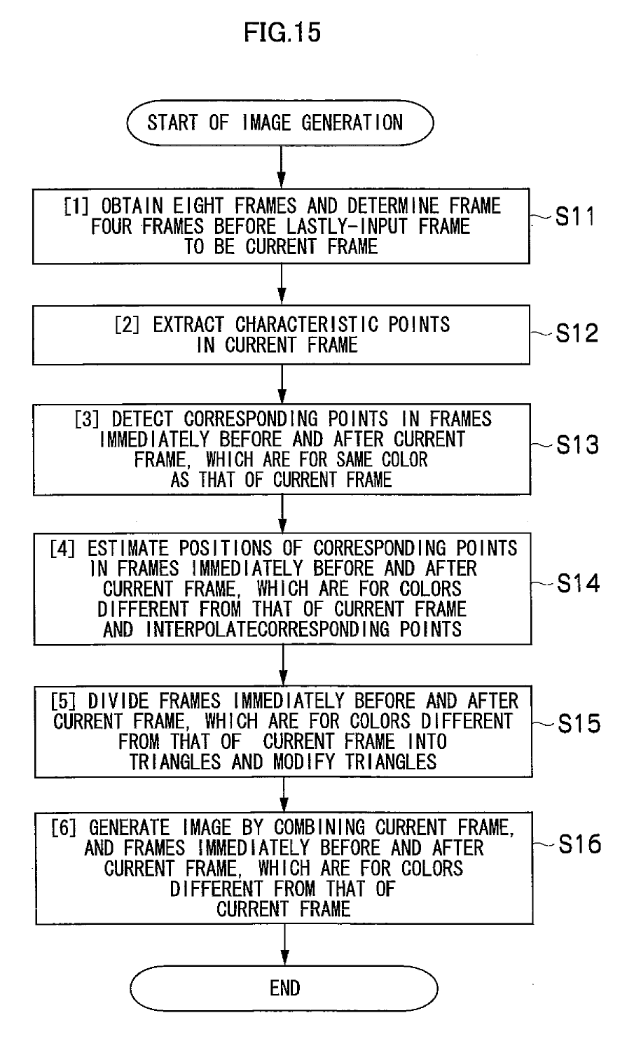

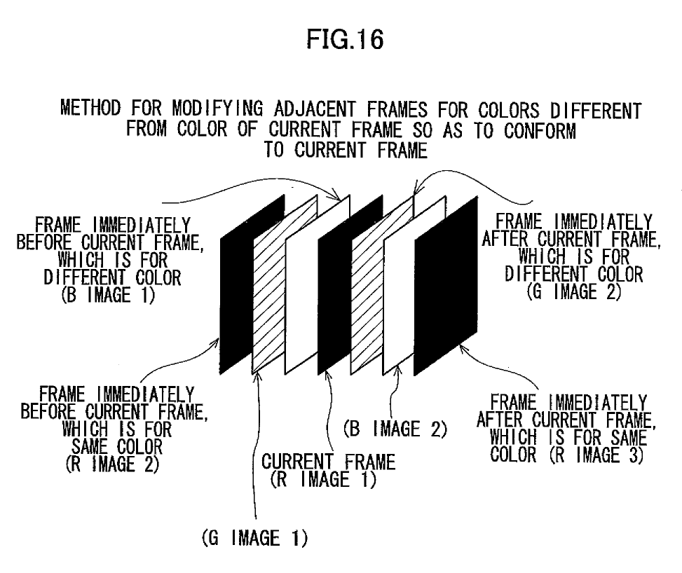

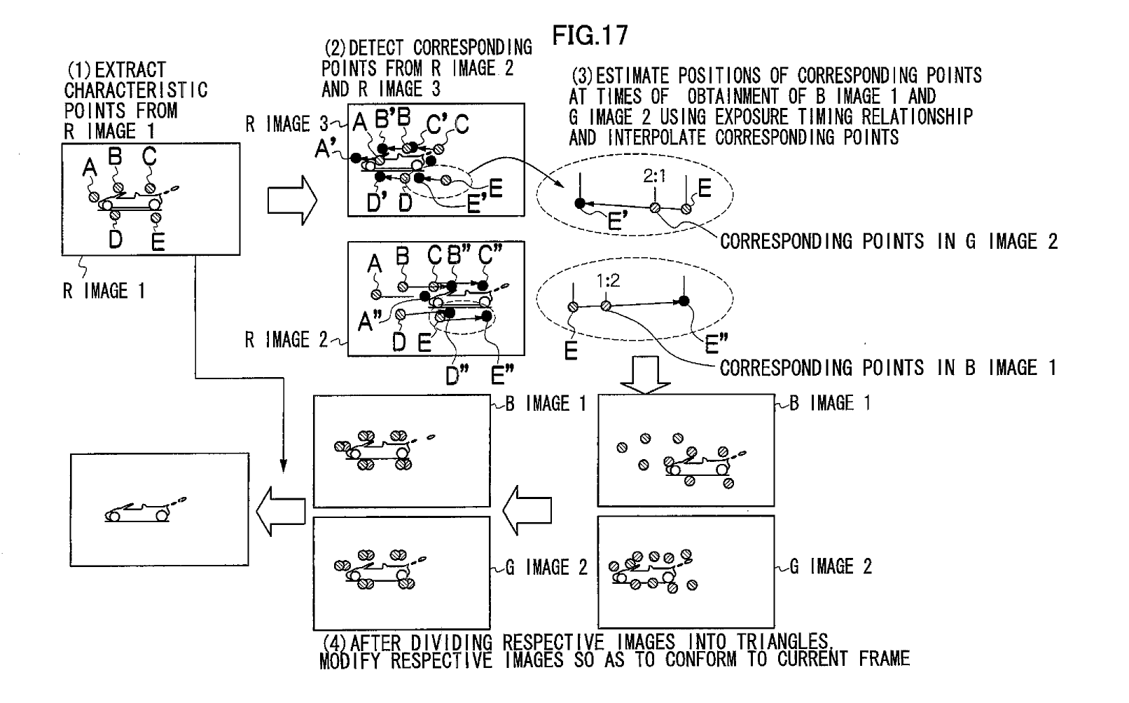

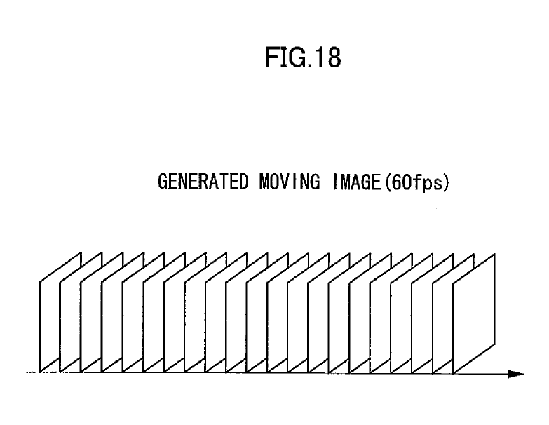

Next, a method for generating image data including three primary colors, R, G and B, from the image data for each of R, G and B will be described with reference to FIGS. 15 to 17. FIG. 15 is a flowchart illustrating the flow of processing for generating image data including three primary colors, R, G and B, FIG. 16 is a diagram schematically illustrating a plurality of image data used for processing for generating image data including three primary colors, R, G and B, and FIG. 17 is a diagram schematically illustrating the state of an image in processing for generating image data including three primary colors, R, G and B.

The latest eight frames including the lastly-input frame are obtained and held in the memory, and the frame four frames before the lastly-input frame is set to be an attention frame (the current frame) (step S11). In other words, supposing that green image data indicated by a white arrow in FIG. 14 is input, as shown in FIG. 15, eight frames including the lastly-obtained G image is held in the memory, and the red image data (R image 1) four frames before the lastly-obtained G image is treated as the current frame.

Characteristic points in the current frame set at step S11 are extracted (step S12; see FIG. 17(1)). Then, corresponding points corresponding to the characteristic points extracted at step S12 are detected from two images for a color that is the same as the color of the image of the current frame and temporally closest to the current frame (step S13).

As shown in FIG. 17(2), since the current frame is the R image 1 in FIG. 15, corresponding points corresponding to the characteristic points in the R image 1 are detected in red image data (R image 2) obtained immediately before the R image 1, and red image data (R image 3) obtained immediately after the R image 1. A″,B″,C″, D″ and E″ are corresponding points in the R image 2 corresponding to the characteristic points A, B, C, D and E in the R image 1, respectively, and A′, B′, C′, D′, E′ are corresponding points in the R image 3 corresponding to the characteristic points A, B, C, D and E in the R image 1, respectively. Where the colors of image data are different from each other, corresponding points may not correctly be detected, but corresponding points can correctly be extracted by extracting the corresponding points in image data for a color that is the same as the color of the image data whose characteristic points have been extracted.

Corresponding points at times of the obtainment of the image of the frame (B image 1) immediately before the current frame and the image of the frame (G image 2) immediately after the current frame are estimated (step S14) from the characteristic points in the R image 1 set at step S12 and the corresponding points in the two images (the R image 2 and the R image 3) for a color that is the same as the color of the current frame and temporally closest to the current frame, which have been detected at step S13. For the estimation method, for example, linear interpolation may be used.

Between the R image 1 and the R image 2, a G image 1 and the B image 1 are obtained at intervals equal to each other. Accordingly, the time between the R image 2 and the B image 1 and the time between the B image 1 and the R image 1 are in a relationship of 2:1. Therefore, as shown in FIG. 17(3), the point whereby the distance between the characteristic point E in the R image 1 and the corresponding point E″ in the R image 2 are divided in a ratio of 2:1 are estimated to be the corresponding point in the B image 1. Similarly, since the time between the R image 1 and the G image 2 and the time between the G image 2 and the R image 3 are in a relationship of 1:2, the point whereby the distance between the characteristic point E in the R image 1 and the corresponding point E′ in the R image 3 are divided in a ratio of 1:2 is estimated to be the corresponding point in the B image 1. As a result of using temporal interpolation as described above, corresponding points in image data for other colors can easily be estimated.

Using the corresponding points generated by means of interpolation at step S14, the images of the frames immediately before and after the current frame are divided into triangles, warping is performed on the triangle regions formed by the characteristic points and thereby modified (step S15). As shown in FIG. 17(4), the triangle regions obtained as a result of division by connecting the corresponding points in the B image 1 are modified so as to match the triangle regions formed by the characteristic points in the R image 1. Similarly, the triangle regions obtained as a result of division by connecting the corresponding points in the G image 2 are modified so as to match the triangle regions formed by the characteristic points in the R image 1. Consequently, the contents of the B image 1 and the G image 2 and the content of the R image 1 are matched.

Lastly, an image including three primary colors, R, G and B, is generated by combining the images immediately before and after the current frame, which have been modified at step S15, and the image of the current frame (step S16; see FIG. 17(5)). As shown in FIG. 17(4), the contents of the B image 1 and the G image 2 and the content of the R image 1 are matched as a result of step S15, and thus, a color image including three primary colors, R, G and B, and having the same content as that of the R image 1 is generated by combining the B image 1, the G image 2 and the R image 1. The color image has a resolution equal to the total of the resolutions of the respective image data, i.e., a resolution three times the resolution of each image data. As described above, a color image is generated by combination, enabling enhancement of the resolution of an image.

A moving image with a frame rate three times the frame rate of each of the image pickup devices 128d, 128e and 128f can be obtained by performing the above-described processing at steps S11 to S16 at the timings for loading all the images.

According to the present embodiment, when a plurality of image pickup devices each having a single-color filter are driven simultaneously, an image with excellent color reproducibility, which does not cause false colors in principle, can be obtained, and these image pickup devices are driven in such a manner which they are temporally shifted from one another, a moving image with a frame rate three times the capacity of each image pickup device can be obtained. Also, a color image is generated by combination, enabling provision of a moving image with a resolution three times the capacity of each image pickup device.

Furthermore, according to the present embodiment, a low frame rate is only necessary for the frame rate required for each image pickup device, enabling reduction of the costs.

In the present embodiment, image data that is different from the image data of the current frame only in terms of color is generated by obtaining corresponding points in the image data of the frames immediately before and after the current frame from characteristic points in the current frame and corresponding points in the frames obtained immediately before and after the current frame, the colors of the frames being the same as the color of the current frame, and modifying the image data in the frames immediately before and after the current frame based on the characteristic points in the current frame and the corresponding points in the image data of the frames immediately before and after the current frame, but a method for generating image data that is different from the image data of the current frame only in terms of color is not limited to this method, and a method as described below may be employed.

Characteristic points in the R image 2 are extracted, and corresponding points in the R image 1, which correspond to the characteristic points in the R image 2 are detected. Corresponding points at the times of the obtainment of the G image 1 and the B image 1 are estimated based on the characteristic points in the R image 2 and the corresponding points in the R image 1. For the estimation method, for example, linear interpolation can be used. Red image data having the same content as those of the G image 1 and the B image 1 is generated by modifying the R image 2 (or the R image 1) based on the characteristic points in the R image 2 and the estimated corresponding points.

Green image data having the same content as those of the B image 1 and the R image 1 is generated by performing similar processing for the G image 1 and the G image 2. As a result, the red image data and the green image data, which have the same content as that of the B image 1, are generated, and a color image including three primary colors, R, G and B, and having the same content as that of the B image 1 is generated by combining these red image data and green image data and the B image 1.

The present invention is applied not only to digital cameras, but may also be applied to image pickup devices in camera-equipped mobile phones and video cameras, and electronic devices in which the firmware can be updated, such as portable music players and PDAs.

What is claimed is:

1. A moving image generating apparatus comprising:
an obtaining device which obtains a series of image data in which high-resolution first image data obtained at a predetermined frame rate and low-resolution second image data obtained at times that are different from the times of the obtainment of the first image data are arranged in a given order;
a characteristic point extracting device which extracts characteristic points in the first image data;
a corresponding point detecting device which detects corresponding points in the second image data, the corresponding points corresponding to characteristic points in first image data obtained immediately before the second image data; and
a generating device which generates high-resolution image data having a content that is the same as that of the second image data by modifying the first image data based on the relationship between the characteristic points extracted by the characteristic point extracting device and the corresponding points detected by the corresponding point detecting device.

2 The moving image generating apparatus according to claim 1, further comprising a resolution converting device which converts the resolution of the first image data to a resolution that is the same as the resolution of the second image data, wherein
the characteristic point extracting device extracts characteristic points in the first image data whose resolution has been converted by the resolution converting device.

3. The moving image generating apparatus according to claim 2, further comprising a coordinate converting device which converts coordinates of the characteristic points extracted by the characteristic point extracting device and the corresponding points detected by the corresponding point detecting device so as to conform to the resolution of the first image data, wherein
the generating device modifies the first image data so that the characteristic points in the first image data whose coordinates have been converted by the coordinate converting device match the corresponding points whose coordinates have been converted by the coordinate converting device.

4. The moving image generating apparatus according to claim 1, farther comprising a region dividing device which divides the first image data into a plurality of regions by connecting the characteristic points extracted by the characteristic point extracting device, wherein
the generating device modifies the regions obtained as a result of the division by the region dividing device so as to conform to the matching of the characteristic points extracted by the characteristic point extracting device to the corresponding points detected by the corresponding point detecting device.

5. The moving image generating apparatus according to claim 2, farther comprising a region dividing device which divides the first image data into a plurality of regions by connecting the characteristic points extracted by the characteristic point extracting device, wherein
the generating device modifies the regions obtained as a result of the division by the region dividing device so as to conform to the matching of the characteristic points extracted by the characteristic point extracting device to the corresponding points detected by the corresponding point detecting device.

6. The moving image generating apparatus according to claim 3, further comprising a region dividing device which divides the first image data into a plurality of regions by connecting the characteristic points extracted by the characteristic point extracting device, wherein
the generating device modifies the regions obtained as a result of the division by the region dividing device so as to conform to the matching of the characteristic points extracted by the characteristic point extracting device to the corresponding points detected by the corresponding point detecting device.

7. A moving image shooting apparatus comprising:
the moving image generating apparatus according to claim 1;
an image pickup device capable of performing high-resolution and low-frame rate operation and low-resolution and high-frame rate operation in a given manner; and
an image pickup controlling device which makes the obtaining device obtain the series of image data in which the first image data and the second image data are arranged in a given order, by controlling the high-resolution and low-frame rate operation and the low-resolution and high-frame rate operation of the image pickup device.

8. The moving image shooting apparatus according to claim 7, wherein the generating device generates high-resolution image data as an interpolation between the high-frame rate first image data and the generated high-resolution image data, in order to obtain successive high-frame rate and high-resolution image data.

9. A moving image shooting apparatus comprising:
the moving image generating apparatus according to claim 1;
a first image pickup device which obtains the first image data;
a second image pickup device which obtains the second image data;
a light dividing device which divides light from a subject so that the light enters the first image pickup device and the second image pickup device; and
an image pickup controlling device which makes the obtaining device obtain the series of image data in which the first image data and the second image data are arranged in a given order, by driving the first image pickup device and the second image pickup device, respectively.

10. A moving image generating apparatus comprising:
an obtaining device which obtains image data for respective three primary colors in turn at a same frame rate and at different timings;
a characteristic point extracting device which extracts characteristic points in image data of an attention frame from among the image data obtained by the obtaining device;
a corresponding point extracting device which extracts corresponding points in image data for a color that is the same as the color of the image data of the attention frame, the image data being obtained at a timing closest to the timing of the obtainment of the image data of the attention frame, the corresponding points corresponding to the characteristic points in the image data of the attention frame extracted by the characteristic point extracting device;
an estimating device which estimates corresponding points in image data for colors that are different from the color of the image data of the attention frame, the image data being adjacent to the image data of the attention frame, based on the distances between the characteristic points extracted by the characteristic point extracting device and the corresponding points extracted by the corresponding point extracting device, and the timings of the obtainment of the image data by the obtaining device;
a first generating device which generates image data for a time that is the same as the time of the obtainment of the image data of the attention frame and for colors that are different from the color of the image data of the attention frame, by modifying the image data for colors that are different from the color of the image data of the attention frame, the image data being adjacent to the image data of the attention frame, based on the characteristic points extracted by the characteristic point extracting device and the corresponding points estimated by the estimating device; and
a second generating device which generates image data including three primary colors for image data for the attention frame, by combining the image data of the attention frame, and the image data for a time that is the same as the time of the obtainment of the image data of the attention frame and for colors that are different from the color of the image data of the attention frame, which have been generated by the first generating device.

11. The moving image generating apparatus according to claim 10, further comprising a setting device which, upon obtainment of image data of seven frames by the obtaining device, sets image data obtained three frames before image data of a lastly-obtained frame to be the image data of the attention frame.

12. The moving image generating apparatus according to claim 10, further comprising
a region dividing device which divides the image data adjacent to the image data of the attention frame into a plurality of regions by connecting the corresponding points estimated by the estimating device, wherein
the first generating device modifies the regions obtained as a result of the division by the region dividing device, so as to conform to the matching of the corresponding points estimated by the estimating device to the characteristic points extracted by the characteristic point extracting device.

13. The moving image generating apparatus according to claim 11, further comprising
a region dividing device which divides the image data adjacent to the image data of the attention frame into a plurality of regions by connecting the corresponding points estimated by the estimating device, wherein
the first generating device modifies the regions obtained as a result of the division by the region dividing device, so as to conform to the matching of the corresponding points estimated by the estimating device to the characteristic points extracted by the characteristic point extracting device.

14. A moving image generating apparatus comprising:
an obtaining device which obtains image data for respective three primary colors in turn at a same frame rate and at different timings;
a characteristic point extracting device which extracts a characteristic point in image data for a color that is different from the color of image data of an attention frame from among the image data obtained by the obtaining device, the image data being obtained at a timing closest to the timing of the obtainment of the image data of the attention frame;
a corresponding point extracting device which extracts a corresponding point in image data for a color that is the same as the color of the image data whose characteristic point has been extracted, which is obtained at a timing closest to the obtainment of the image data whose characteristic point has been extracted, with the timing of the obtainment of the attention frame between the timing of the obtainment of the image data whose characteristic point has been extracted and the timing of the obtainment of the image data, the corresponding point corresponding to the characteristic point extracted by the characteristic point extracting device;
an estimating device which estimates corresponding points in image data for a time that is the same as the time of the obtainment of the attention frame and for colors that are different from the color of the attention frame, based on the distance between the characteristic point extracted by the characteristic point extracting device and the corresponding point extracted by the corresponding point extracting device, and the timings of the obtainment of the image data by the obtaining device;
a first generating device which generates the image data for a time that is the same as the time of the obtainment of the image data of the attention frame and for colors that are different from the color of the image data of the attention frame, by modifying the image data whose characteristic point has been extracted by the characteristic point extracting device, based on the characteristic point extracted by the characteristic point extracting device and the corresponding points estimated by the estimating device, or modifying the image data whose corresponding point has been extracted by the corresponding point extracting device, based on the corresponding point extracted by the corresponding point extracting device and the corresponding points estimated by the estimating device; and
a second generating device which generates image data including three primary colors for image data for the attention frame, by combining the image data of the attention frame and the image data for a time that is the same as the time of the obtainment of the image data of the attention frame and for colors that are different from the color of the image data of the attention frame, which have been generated by the first generating device.

15. A moving image shooting apparatus comprising:
the image generating apparatus according to claim 10;
a plurality of image pickup devices which obtain image data for respective three primary colors;
a light dividing device which divides light from a subject and makes the light enter the plurality of image pickup devices;
an image pickup controlling device which makes the obtaining device obtain the image data for respective three primary colors, which have been obtained in turn at a same frame rate and at different timings, by performing exposures of the plurality of image pickup devices in turn at times shifted from each other; and
a reproducing device which reproduces a moving image generated by the second generating device.

16. A moving image shooting apparatus comprising:
the image generating apparatus according to claim 14;
a plurality of image pickup devices which obtain image data for respective three primary colors;
a light dividing device which divides light from a subject and makes the light enter the plurality of image pickup devices;
an image pickup controlling device which makes the obtaining device obtain the image data for respective three primary colors, which have been obtained in turn at a same frame rate and at different timings, by performing exposures of the plurality of image pickup devices in turn at times shifted from each other; and
a reproducing device which reproduces a moving image generated by the second generating device.

17. A moving image generating method comprising the steps of:
(a) obtaining a series of image data in which high-resolution first image data obtained at a predetermined frame rate and low-resolution second image data obtained at times that are different from the times of the obtainment of the first image data are arranged in a given order;
(b) extracting a characteristic point in the first image data;
(c) detecting a corresponding point in the second image data, the corresponding point corresponding to a characteristic point in first image data obtained immediately before the second image data;
(d) generating high-resolution image data having a content that is the same as that of the second image data by modifying the first image data based on the extracted characteristic point and the detected corresponding point; and
(e) performing steps (b) to (d) for all the second image data obtained at step (a).

18. A moving image generating method comprising the steps of:
(a) obtaining image data for respective three primary colors obtained in turn at a same frame rate and at different timings;
(b) extracting a characteristic point in image data of an attention frame from among the obtained image data;
(c) extracting a corresponding point in image data for a color that is the same as the color of the image data of the attention frame, the image data being obtained at a timing closest to the timing of the obtainment of the image data of the attention frame, the corresponding point corresponding to the extracted characteristic point in the image data of the attention frame;
(d) estimating corresponding points in image data for colors that are different from the color of the image data of the attention frame, the image data being adjacent to the image data of the attention frame, based on the distance between the characteristic point in the image data of the attention frame, which has been extracted at step (B), and the corresponding point in the image data for a color that is the same as the color of the image data of the attention frame, the image data being obtained at a timing closest to the timing of the obtainment of the image data of the attention frame, which has been extracted at step (c), and the timings of the obtainment of the image data at step (a);
(e) generating image data for a time that is the same as the time of the obtainment of the attention frame and for colors that are different from the color of the attention frame, by modifying the image data adjacent to the image data of the attention frame based on the obtained characteristic point and the estimated corresponding point;
(f) generating image data including three primary colors for image data for the attention frame, by combining the image data of the attention frame, and the generated image data for a time that is the same as the time of the obtainment of the attention frame and for colors that are different from the color of the attention frame; and
(g) performing steps (b) to (f) for all the image data obtained at step (a).

19. A recording medium which stores computer readable code of a program for making an arithmetic device execute the moving image generating method according to claim 17.

20. A recording medium which stores computer readable code of a program for making an arithmetic device execute the moving image generating method according to claim 18.
